(19) United States
(12) Patent Application Publication
(10) Pub. No.: US 2025/0379656 A1
(43) Pub. Date: Dec. 11, 2025

(54) MULTICHANNEL BIDIRECTIONAL OPTICAL TRANSCEIVER

(71) Applicant: ELECTRONICS AND TELECOMMUNICATIONS RESEARCH INSTITUTE, Daejeon (KR)

(72) Inventors: Han-Hyub LEE, Daejeon (KR); Hwan-Seok CHUNG, Daejeon (KR)

(73) Assignee: ELECTRONICS AND TELECOMMUNICATIONS RESEARCH INSTITUTE, Daejeon (KR)

(21) Appl. No.: 19/221,346

(22) Filed: May 28, 2025

(30) Foreign Application Priority Data
Jun. 5, 2024 (KR) 10-2024-0073697
Apr. 30, 2025 (KR) 10-2025-0057715

(51) Int. Cl. H04B 10/40; H04B 10/50

(52) U.S. Cl. CPC H04B 10/40; H04B 10/506

(57) ABSTRACT

Disclosed herein is a multichannel bidirectional optical transceiver. The multichannel bidirectional optical transceiver may include a transmission unit for transmitting optical signals with two or more different wavelengths, a reception unit for receiving optical signals with two or more different wavelengths, and an optical filter block for multiplexing two or more optical signals transmitted by the transmission unit and outputting the same to a single optical fiber and for demultiplexing two or more optical signals received from the single optical fiber and inputting the same to the reception unit.

### CROSS REFERENCE TO RELATED APPLICATIONS

This application claims the benefit of Korean Patent Applications No. 10-2024-0073697, filed Jun. 5, 2024, and No. 10-2025-0057715, filed Apr. 30, 2025, which are hereby incorporated by reference in their entireties into this application.

### BACKGROUND OF THE INVENTION

### 1. Technical Field

The disclosed embodiment relates to technology for an optical transceiver in an optical access network.

### 2. Description of the Related Art

In optical access networks, a wavelength division multiplexing method, which uses different wavelengths for downstream optical signals and upstream optical signals, respectively, is used to reduce the number of optical fibers used. A point-to-point bidirectional optical access network allows downstream and upstream optical signals to be transmitted and received over a single optical fiber between a telecommunication central office and a user, and this technology is used not only for optical access networks but also for data center interconnects, mobile backhaul, C-RAN, and the like.

Optical links for bidirectional optical access networks use the O-band, which has a relatively higher optical fiber loss than the C-band, but in which transmission is less affected by chromatic dispersion. However, as the transmission rate per wavelength of optical signals increases to 100 Gb/s, the transmission penalty by chromatic dispersion can no longer be ignored even in the O-band. It has been reported that, when transmitting a 100 Gb/s PAM4 optical signal over 40 km, an available wavelength band is limited to 3 nm even in a zero-dispersion window in which a chromatic dispersion value of optical fiber is low.

In order to enable bidirectional optical transmission using wavelength division multiplexing, a wavelength band capable of accommodating at least two optical signal wavelengths is required. Also, when an optical filter is used to implement a Bidirectional Optical Sub-Assembly (BOSA), which is required to bidirectionally transmit and receive optical signals, a wavelength spacing equal to or greater than a certain range is additionally required between upstream and downstream optical signals. Therefore, even though the O-band is used, it is difficult to implement a BOSA capable of supporting 100 Gb/s per wavelength for transmission over 40 km.

### SUMMARY OF THE INVENTION

An object of the disclosed embodiment is to increase the transmission capacity of a bidirectional optical communication system.

Another object of the disclosed embodiment is to reduce the transmission penalty caused by chromatic dispersion by increasing the wavelength of an optical signal, rather than the transmission rate thereof, and to easily increase the transmission capacity of a bidirectional optical communication system.

A multichannel bidirectional optical transceiver according to an embodiment may include a transmission unit for transmitting optical signals with two or more different wavelengths, a reception unit for receiving optical signals with two or more different wavelengths, an optical filter block for multiplexing two or more optical signals transmitted by the transmission unit before outputting the same and for demultiplexing received two or more optical signals before inputting the same to the reception unit, and a receptacle for outputting an optical signal output from the optical filter block to a single optical fiber and inputting an optical signal received from the single optical fiber to the optical filter block.

Here, the optical filter block may include a zigzag block that is a hexahedral glass block configured such that first and second side surfaces facing each other are slanted at the same predetermined angle to be parallel to each other, multiple filters disposed on the first side surface of the zigzag block, each of the multiple filters transmitting only an optical signal with a corresponding wavelength and reflecting optical signals with other wavelengths, and a mirror plane disposed on the second side surface of the zigzag block and configured to reflect an optical signal.

Here, the zigzag block may be designed such that an angle between the first side surface and a bottom surface is equal to or less than 90°−13.5° and an angle between the second side surface and the bottom surface is equal to or greater than 90°+13.5°.

Here, the multiple filters may be spaced less than 1.2 mm apart.

Here, the rear surface of the mirror plane may be coated with a highly reflective layer.

Here, a wavelength of an optical signal used for upstream transmission may include 1295 nm and 1300 nm, and a wavelength of an optical signal used for downstream transmission may include 1304 nm and 1309 nm.

Here, a wavelength of an optical signal used for downstream transmission may include 1295 nm and 1300 nm, and a wavelength of an optical signal used for upstream transmission may include 1304 nm and 1309 nm.

Here, the transmission unit may include, for each of optical signals with two or more different wavelengths, a laser diode for outputting an optical signal with a corresponding wavelength, a collimating lens for aligning an optical signal output from the laser diode into parallel light, and an optical isolator for transmitting an optical signal passing through the collimating lens in a forward direction to be directed to the optical filter block.

Here, the laser diode may use electro-absorption modulated laser or directly modulated laser.

Here, the reception unit may include a prism for changing an angle of a path of each of two or more optical signals output from the optical filter block, focusing lenses for respectively focusing two or more optical signals output from the prism, photodiodes for receiving optical signals passing through the respective focusing lenses, and an amplifier for converting the current input of each of the photodiodes into voltage.

Here, the photodiode may use a PIN photodiode or an avalanche photodiode having high receiving sensitivity.

Here, the multichannel bidirectional optical transceiver according to an embodiment may further include a receptacle collimator for focusing an optical signal output from the optical filter block and transferring the same to the optical fiber and for collimating a received optical signal and transferring the same to the optical filter block.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an exemplary view of a bidirectional optical access network system to which an embodiment is applied;

FIG. 2 is an exemplary view of a general bidirectional optical transceiver;

FIG. 3 is a schematic block diagram illustrating the internal configuration of a multichannel bidirectional optical transceiver according to an embodiment;

FIG. 4 is a structural diagram of a multichannel bidirectional optical transceiver according to an embodiment;

FIG. 5 is an exemplary view of the wavelength range of optical signals transmitted and received by a multichannel bidirectional optical transceiver according to an embodiment;

FIG. 6 is a cross-sectional view for explaining an optical filter block according to an embodiment;

FIGS. 7 and 8 are exemplary views illustrating transmission and reception of optical signals with multichannel wavelengths by an optical filter block according to an embodiment; and

FIGS. 9 and 10 are side views for explaining a prism according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

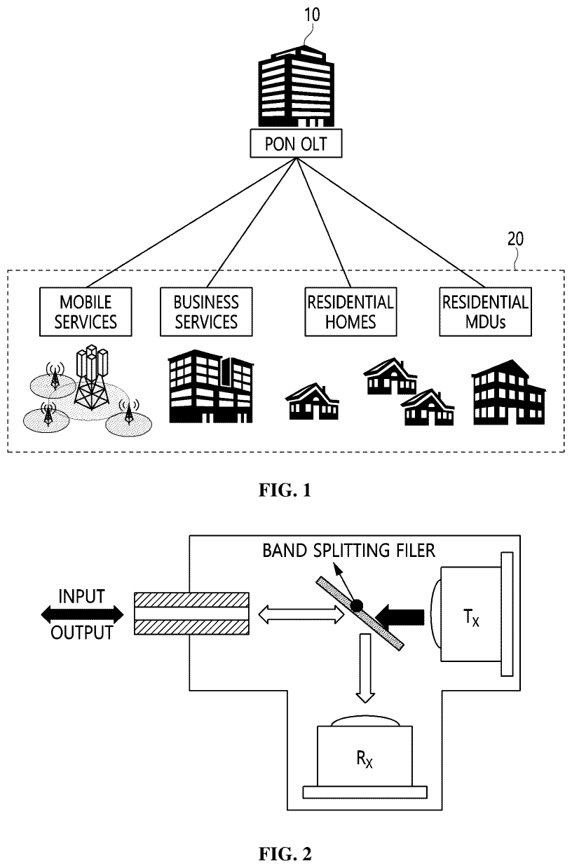

FIG. 1 is an exemplary view of a bidirectional optical access network system to which an embodiment is applied.

Referring to FIG. 1, the bidirectional optical access network system may include an Optical Line Terminal (OLT) 10, which is used for a telecommunications operator to transmit, receive, and control optical signals, and multiple Optical Network Units (ONUs) 20, which transmit and receive optical signals to and from user terminals.

Here, the optical access network uses wavelength division multiplexing, which uses different wavelengths for downstream optical signals and upstream optical signals, respectively, to reduce the number of optical fibers used.

A point-to-point bidirectional optical access network allows upstream optical signals and downstream optical signals to be transmitted and received using a single optical fiber from a central office 10 to a user terminal 20. This technology is used not only for the optical access network, but also for data center interconnects, mobile backhaul, C-RAN, and the like.

In order to use two optical signals with different wavelengths as downstream and upstream signals and to enable bidirectional transmission and reception using a single input/output terminal as described above, a bidirectional optical transceiver is required.

FIG. 2 is an exemplary view of a BOSA used for a general bidirectional optical transceiver.

Referring to FIG. 2, a BOSA for a bidirectional optical transceiver includes a band splitting filter that separates optical signals transmitted and received by a transmission unit Tx and a reception unit Rx.

Bidirectional optical access is a practical solution for increasing optical fiber utilization because optical signals are transmitted and received simultaneously over a single optical fiber using different wavelengths, as shown in FIG. 2. In mobile networks or data center interconnects (DCIs), an optical link between a digital unit (DU) and a radio unit (RU) is a typical application field of bidirectional optical access, with transmission distances ranging from several kilometers to tens of kilometers.

Compared to a conventional duplex optical module, which requires two optical fibers for data transmission and reception, a bidirectional (BiDi) optical module enables bidirectional transmission and reception over a single optical fiber, thereby reducing the number of used optical fibers by half. Also, the number of operating wavelengths of the BiDi optical module is increased using wavelength division multiplexing technology, whereby the transmission capacity of bidirectional optical access may be increased to 100 G, 200 G, and 400 G or more while maintaining the use of a single optical fiber. Therefore, the BiDi optical module plays a critical role in enabling signal transmission and reception over a single optical fiber.

So far, there have been significant efforts to improve the transmission rate and distance of BiDi technology. One common approach to bidirectional transmission is to assign separate wavelengths to upstream and downstream transmission, respectively.

However, one of the major challenges in increasing the capacity of bidirectional optical access by simply increasing the transmission rate of a single wavelength is to balance the transmission rate and distance. As the transmission rate increases, chromatic dispersion becomes more pronounced, which causes transmission penalties and receiver sensitivity degradation. As a result, complex electrical dispersion compensation (EDC) and optical amplification techniques are required to maintain performance.

Accordingly, an embodiment intends to increase the capacity of bidirectional optical access by showing the feasibility of a multi-wavelength BOSA based on a zigzag optical glass block and a thin-film filter (TFT). That is, the effects of chromatic dispersion may be mitigated using a compact wavelength band near the zero-dispersion wavelength of an optical fiber, whereby longer transmission distances and improved system performance may be obtained without the need for complex compensation techniques.

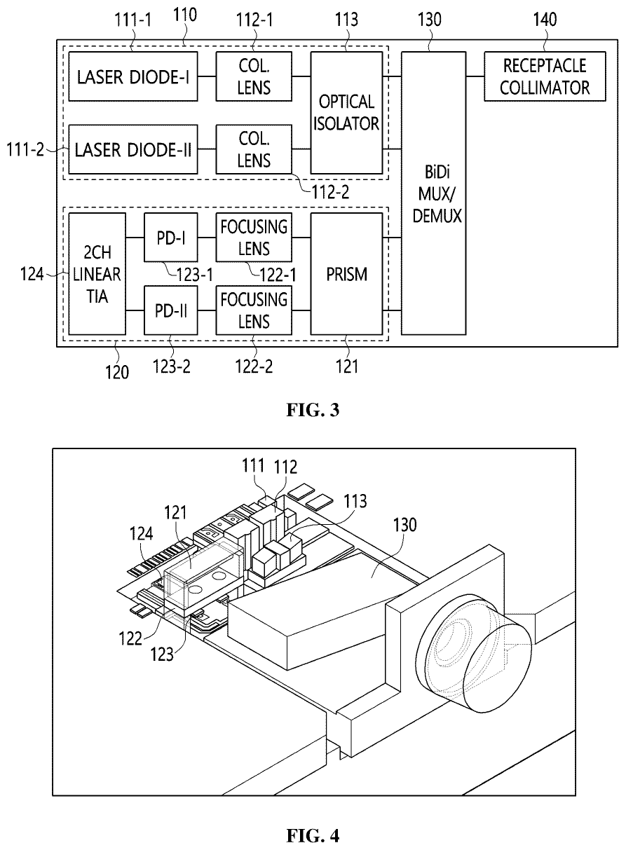

FIG. 3 is a schematic block diagram illustrating the internal configuration of a multichannel bidirectional optical transceiver according to an embodiment, and FIG. 4 is a structural diagram of a multichannel bidirectional optical transceiver according to an embodiment.

Referring to FIGS. 3 and 4, the multichannel bidirectional optical transceiver according to an embodiment may include a transmission unit 110, a reception unit 120, and an optical filter block 130.

Here, the multichannel bidirectional optical transceiver according to an embodiment may further include a receptacle collimator 140 configured to focus an optical signal output from the optical filter block 130 and to collimate a received optical signal and then transfer the same to the optical filter.

The transmission unit 110 outputs optical signals with two or more different wavelengths to the optical filter block 130.

The reception unit 120 receives optical signals with two or more different wavelengths from the optical filter block 130.

Here, both the transmitted and received optical signals may be signals of different wavelength ranges.

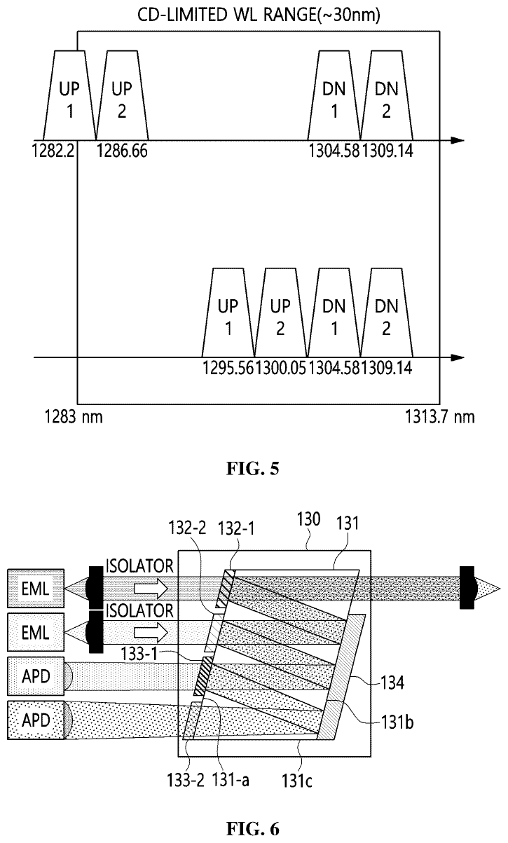

FIG. 5 is an exemplary view of the wavelength range of optical signals transmitted and received by a multichannel bidirectional optical transceiver according to an embodiment.

For example, referring to FIG. 5, the wavelength of an optical signal used for upstream transmission may include 1295 nm and 1300 nm, and the wavelength of an optical signal used for downstream transmission may include 1304 nm and 1309 nm.

Alternatively, although not illustrated in the drawing, the wavelength of an optical signal used for downstream transmission may include 1295 nm and 1300 nm and the wavelength of an optical signal used for upstream transmission may include 1304 nm and 1309 nm in another example.

Hereinafter, the case in which only two optical signals are transmitted and only two optical signals are received will be described in order to help understanding of the present disclosure. However, the present disclosure is not limited thereto, and two or more optical signals may be transmitted and received.

The optical filter block 130 may multiplex at least two optical signals transmitted by the transmission unit 110 and output the same to a single optical fiber via the receptacle 140, and may demultiplex at least two signals received from the single optical fiber via the receptacle 140 and input the same to the reception unit 120.

Here, the optical signals entering to the optical filter block 130 may be reflected multiple times and separated depending on the wavelength.

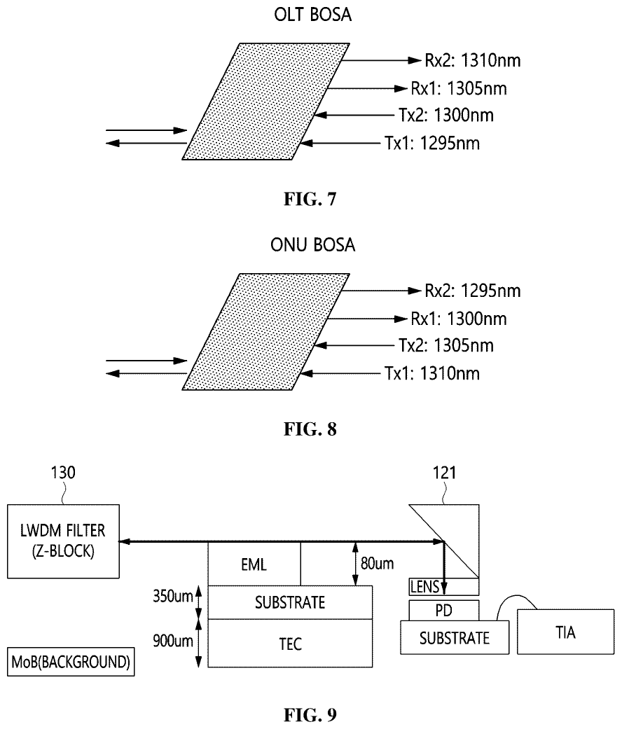

FIG. 6 is a cross-sectional view for explaining an optical filter block according to an embodiment, and FIGS. 7 and 8 are exemplary views of transmission and reception of optical signals with multichannel wavelengths by an optical filter block according to an embodiment.

Referring to FIG. 6, the optical filter block 130 may include a zigzag block 131, multiple filters 132-1, 132-2, 133-1, 133-2, and a mirror plane 134.

Here, the zigzag block 131 is a hexahedral glass block and may have a structure in which first and second side surfaces 131a and 131b facing each other are slanted at the same predetermined angle to be parallel to each other.

Here, the zigzag block 131 may be designed such that the angle between the first side surface 131a and the bottom surface 131c is equal to or less than 90°−13.5° and the angle between the second side surface 131b and the bottom surface 131c is equal to or greater than 90°+13.5°.

The multiple filters 132-1, 132-2, 133-1, and 133-2 are disposed on the first side surface 131a of the zigzag block 131, and each of which transmits only the optical signal with a corresponding wavelength and reflects optical signals with other wavelengths. Here, the multiple filters 132-1, 132-2, 133-1, and 133-2 may be Thin-Film Filters (TFFs) in which multiple thin films are stacked.

Here, the multiple filters may be spaced less than 1.2 mm apart.

The mirror plane 134 is disposed on the second side surface of the zigzag block 131 and may reflect an optical signal.

Here, the mirror plane may be coated with a highly reflective layer.

Accordingly, for example, a first optical signal output from the transmission unit 110 may be output after passing through the filter 132-1, and a second optical signal output from the transmission unit 110 may be output after it passes through the filter 132-2 and is then sequentially reflected by the mirror plane 134 and the filter 132-1. That is, the first and second optical signals output from the transmission unit 100 may be multiplexed in this way.

Also, a third optical signal received is sequentially reflected by the filter 132-1, the mirror plane 134, the filter 132-2, and the mirror plane 134 and then passes through the filter 133-1, thereby being input to the reception unit 120. A fourth optical signal received is sequentially reflected by the filter 132-1, the mirror plane 134, the filter 132-2, the mirror plane 134, the filter 133-1, and the mirror plane 134 and then passes through the filter 133-2, thereby being input to the reception unit 120.

In other words, the received optical signals may be demultiplexed into the third optical signal and the fourth optical signal and input to the reception unit 120.

Referring to FIG. 7, for example, the optical filter block in the OLT 10 may multiplex optical signals with two wavelengths of 1295 nm and 1300 nm, which are used for downstream transmission, and may demultiplex upstream optical signals into optical signals with two wavelengths of 1305 nm and 1310 nm.

Also, referring to FIG. 8, for example, the optical filter block in the ONU 20 may demultiplex downstream optical signals into optical signals with two wavelengths of 1295 nm and 1300 nm, and may multiplex upstream optical signals with two wavelengths of 1305 nm and 1310 nm.

Meanwhile, referring to FIGS. 3 and 4 again, the transmission unit 110 may include laser diodes 111-1 and 111-2 for outputting an optical signal with a corresponding wavelength, collimating lenses 112-1 and 112-2 for aligning the optical signal output from the laser diodes 111-1 and 111-2 into parallel light, and an optical isolator 113 that allows the optical signal passing through the collimating lens 112-1 or 112-2 to pass in a forward direction to be directed to the optical filter block 130.

Here, the laser diodes 111-1 and 111-2 may be electro-absorption modulated laser diodes or directly modulated laser diodes.

Here, two or more laser diodes 111-1 and 111-2 and two or more collimating lenses 112-1 and 112-2 may be provided to correspond to optical signals with two or more different wavelengths.

Also, the reception unit 120 may include a prism 121 for changing the angle of the path of each of two or more optical signals output from the optical filter block 130, focusing lenses 122-1 and 122-2 for respectively focusing two or more optical signals output from the prism 121, photodiodes 123-1 and 123-2 for receiving optical signals passing through the respective focusing lenses 122-1 and 122-2, and an amplifier 124 for converting the current input of each of the photodiodes 123-1 and 123-2 into voltage.

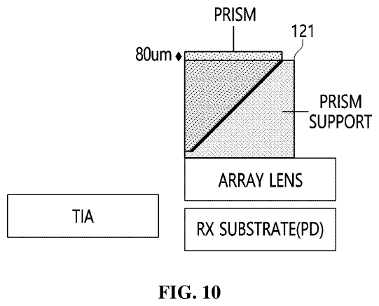

FIGS. 9 and 10 are side views for explaining a prism according to an embodiment.

Referring to FIGS. 9 and 10, the prism 121 changes the path of an optical signal incident from the optical filter block 130 vertically by an angle of 90 degrees to be incident on a condensing lens.

According to the disclosed embodiment, the capacity demands may be met in both wired and wireless networks, as well as in data center interconnections.

According to the disclosed embodiment, the impact of chromatic dispersion is reduced without decreasing the transmission rate of optical signals even over a single optical fiber, whereby a transmission distance may be increased.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A multichannel bidirectional optical transceiver, comprising:
a transmission unit for transmitting optical signals with two or more different wavelengths;
a reception unit for receiving optical signals with two or more different wavelengths;
an optical filter block for multiplexing two or more optical signals transmitted by the transmission unit before outputting the optical signals and for demultiplexing received two or more optical signals before inputting the optical signals to the reception unit; and
a receptacle for outputting an optical signal output from the optical filter block to a single optical fiber and inputting an optical signal received from the single optical fiber to the optical filter block.

2. The multichannel bidirectional optical transceiver of claim 1, wherein the optical filter block includes
a zigzag block that is a hexahedral glass block configured such that first and second side surfaces facing each other are slanted at a same predetermined angle to be parallel to each other;
multiple filters disposed on the first side surface of the zigzag block, each of the multiple filters transmitting only an optical signal with a corresponding wavelength and reflecting optical signals with other wavelengths; and
a mirror plane disposed on the second side surface of the zigzag block and configured to reflect an optical signal.

3. The multichannel bidirectional optical transceiver of claim 2, wherein the zigzag block is designed such that an angle between the first side surface and a bottom surface is equal to or less than 90°−13.5° and an angle between the second side surface and the bottom surface is equal to or greater than 90°+13.5°.

4. The multichannel bidirectional optical transceiver of claim 2, wherein the multiple filters are spaced less than 1.2 mm apart.

5. The multichannel bidirectional optical transceiver of claim 1, wherein
a wavelength of an optical signal used for upstream transmission includes 1295 nm and 1300 nm, and
a wavelength of an optical signal used for downstream transmission includes 1304 nm and 1309 nm.

6. The multichannel bidirectional optical transceiver of claim 1, wherein
a wavelength of an optical signal used for downstream transmission includes 1295 nm and 1300 nm, and
a wavelength of an optical signal used for upstream transmission includes 1304 nm and 1309 nm.

7. The multichannel bidirectional optical transceiver of claim 1, wherein the transmission unit includes, for each of optical signals with two or more different wavelengths,
a laser diode for outputting an optical signal with a corresponding wavelength;
a collimating lens for aligning an optical signal output from the laser diode into parallel light; and
an optical isolator for transmitting an optical signal passing through the collimating lens in a forward direction to be directed to the optical filter block.

8. The multichannel bidirectional optical transceiver of claim 7, wherein the laser diode is a directly modulated laser diode or an electro-absorption modulated laser diode.

9. The multichannel bidirectional optical transceiver of claim 2, wherein the reception unit includes
a prism for changing an angle of a path of each of two or more optical signals output from the optical filter block;
focusing lenses for respectively focusing two or more optical signals output from the prism;
photodiodes for receiving optical signals passing through the respective focusing lenses; and
an amplifier for converting current input of each of the photodiodes into voltage.

10. The multichannel bidirectional optical transceiver of claim 9, wherein the photodiode is a PIN photodiode or an avalanche photodiode.

11. The multichannel bidirectional optical transceiver of claim 1, further comprising:
a receptacle collimator for focusing an optical signal output from the optical filter block and transferring a received optical signal to the optical filter block after collimating the received optical signal.
